(19) United States
(12) Patent Application Publication
(10) Pub. No.: US 2009/0147502 A1
(43) Pub. Date: Jun. 11, 2009

(54) ILLUMINATED BACKGROUND SYSTEM FOR AQUARIUM

(76) Inventor: Thomas Aleman, Akron, OH (US)

Correspondence Address: HAHN LOESER & PARKS, LLP, One GOJO Plaza, Suite 300, AKRON, OH, 44311-1076, US

(21) Appl. No.: 11/953,299

(22) Filed: Dec. 10, 2007

(51) Int. Cl. F21V 33/00; F21V 7/00; A01K 63/06; A47F 11/10

(52) U.S. Cl. 362/101; 362/310; 362/125; 119/246

(57) ABSTRACT

The present invention relates generally to an illuminating apparatus and more particularly to an apparatus designed to backlight a decorative scene that may be adhered or otherwise disposed adjacent to a wall of an aquarium, terrarium, or similar enclosure. The apparatus may also be used to effectively illuminate the interior of an enclosure such as an aquarium or terrarium through a transparent side wall thereof.

### FIELD OF INVENTION

The present invention relates generally to a simply produced and used illuminating apparatus and more particularly to an apparatus designed to backlight a decorative scene that may be provided in association therewith or disposed adjacent to a wall of an aquarium, terrarium, or similar enclosure. The apparatus may also be used to effectively illuminate the interior of an enclosure such as an aquarium or terrarium through a transparent side wall thereof.

### BACKGROUND

Aquariums, terrariums, and other enclosures designed with transparent walls to allow the interior to be viewed are normally lighted, if at all, from a light source located in the lid or cover of the enclosure. To make the appearance of the enclosure more aesthetically pleasing, these types of enclosures may include decorative backgrounds such as a thin sheet of plastic having a decorative scene thereon adhered to or otherwise disposed adjacent to the back wall or side walls thereof. Light from the lid's light source may illuminate the decorative background to some degree, or if the enclosure is positioned properly, light from a window or other source, such as an ordinary lamp, may illuminate the decorative scene from outside the enclosure to provide an aesthetically pleasing background scene to the aquarium or terrarium. Although somewhat effective, these arrangements do not provide the correct source of light to effectively illuminate a decorative background. Normally, the aquarium or terrarium is not positioned in front of or adjacent to a window or a lamp. Further, these sources of light would usually not provide sufficient light throughout the day to effectively illuminate the background. Obviously, a window would generally only allow light in during “daylight” hours. An ordinary lamp would also be ineffective because it provides an unevenly distributed source of light, and thus any extraneous illumination is generally ineffective.

### SUMMARY

The present invention is therefore directed to an apparatus for illuminating a decorative scene disposed adjacent to or in proximity to a wall of an aquarium, terrarium, or other such enclosure. The invention provides an easy to use apparatus that effectively and uniformly illuminates a decorative background, which is selectively positioned within a mounting system associated with the illuminating system. The system is suitable for use with a wide variety of shapes and sizes of these types of enclosures. The invention is also cost effective to produce and use.

In an example, the invention comprises first and second housing members formed as left and right hand members having triangular or other shaped side walls and first and second flanges extending away from the side wall along two sides. In one example, the housing members may be formed to have approximately the cross-sectional shape of a right triangle such that the right angle is formed where the top wall of the housing member meets the top region of a wall of the enclosure to which the apparatus is attached. The side wall of each housing member may be dimensioned to correspond to the height of an enclosure with which it is to be used. The flanges extend inwardly from the side wall on each of the right and left hand members, or toward the other housing member when positioned for use in association with an enclosure. The first and second housing members may be positioned adjacent an edge of the enclosure along a wall thereof for use. To facilitate positioning of the housing members in association with an enclosure, the housing members may further comprise an attachment system allowing the members to be selectively attached to the enclosure. A background scene or the like may then be positioned in association with the housing members to extend between the members and thereby form a cavity having the background scene as a part thereof, such that the background scene is positioned in proximity to a wall of the enclosure. A light source may then be used to project illuminating light into the formed cavity, and thereby illuminate the background such that is uniformly illuminated from the front or behind, thereby enhancing the appearance of the enclosure when viewed. There may also be provided a center plate member adapted to connect the first and second housing members along a back portion thereof, between extending flanges on each housing member, if desired. The center plate member may be connected to the end housing members, such that a cavity is formed into which illuminating light may be directed. If the first and second housing members are formed as having a triangular shape, the center plate member may then be attached so as to be inclined relative to the wall of the enclosure. A background may be selectively attached adjacent a wall of the enclosure, such that illuminating light is reflected from the end housing members and center plate member toward the background, so as to illuminate the background from behind it and into the enclosure. The center plate member may be dimensioned such that in association with the housing members, the formed cavity is approximately the dimension of the wall of the enclosure with which it is used. The center plate member may have a top flange which extends toward the wall of the enclosure when positioned therewith if desired, and may also include a bottom support to facilitate positioning of the background in association therewith. The housing members may be cost-effectively formed by molding of a plastic material for example.

In another example, the invention comprises a housing defining a cavity into which illuminating light may be projected. The cavity may be formed such that the inner surface is reflective to illuminate a background positioned adjacent a wall of an enclosure. The housing may include an attachment system to allow selective attachment to an enclosure along a wall thereof. The housing may have a cross-sectional shape such that the reflective cavity will cause light from a light source to be uniformly reflected out through an open end or mouth of the cavity. In this example, the back wall may be inclined toward the enclosure from top to bottom to uniformly reflect light into the enclosure at substantially a right angle to the wall of the enclosure.

If desired, the housing may be adjustable in size to allow the apparatus to be utilized in conjunction with a variety of sizes of aquaria, terraria, or other such enclosures. This adjustability may be accomplished by forming housing from two or more separate members designed to be slidably connected. The members may be formed such that they slidably allow for the adjustment of the height of the apparatus, or adjustment of the lengthwise dimensions of the housing. The system may be formed of flat blanks which are easily folded and constructed to form the reflective enclosure, while allowing simplified and cost-effective manufacture and shipping.

Based upon the foregoing, the invention will provide an apparatus that is selectively attached to an aquarium, terrarium, or the like. If desired, the invention will provide uniform illumination through a wall of the enclosure to illuminate an entire decorative background provided in association with the wall of the enclosure, thereby dramatically improving the aesthetic appearance of the aquarium or the like.

### BRIEF DESCRIPTION OF THE DRAWINGS

The aforementioned aspects of the invention will become apparent upon a further reading of the Description taken in conjunction with the accompanying drawings, wherein,

FIG. 1 shows an example of the invention relating to first and second housing members.

FIG. 2 shows a center plate member which may be used with the first and second housing members shown in FIG. 1.

FIG. 3 shows a reflective cavity formed by the first and second housing members of FIG. 1 and the center plate member of FIG. 2.

FIG. 3A shows an alternative plate member to facilitate forming the reflective cavity in association with the first and second housing members of FIG. 1.

FIG. 4 is an end elevational view of a further example of the invention, partially broken away and in section, illustrating the illuminating apparatus as it may be applied to an enclosure;

FIG. 4A is an end elevational view of another example of the invention, partially broken away and in section, illustrating another application of the illuminating apparatus;

FIG. 5 is a perspective view of an example of the apparatus of the invention, illustrating lengthwise adjustability; and,

FIG. 6 is a perspective view of an alternative example of the apparatus illustrating height adjustability of the apparatus.

FIG. 7 is a top view of an example of unassembled apparatus formed as a flat member to facilitate manufacture and shipping.

FIG. 8 is a top view of another example of unassembled apparatus formed as several flat members to facilitate manufacture and shipping.

FIG. 9 is a perspective view of a diffuser type lens which can be used in association with the apparatus of the invention.

FIG. 10 is a perspective view of a lens suitable for use with the apparatus of the invention.

### DESCRIPTION OF THE INVENTION

Detailed reference will now be made to several examples of the invention in the accompanying drawings.

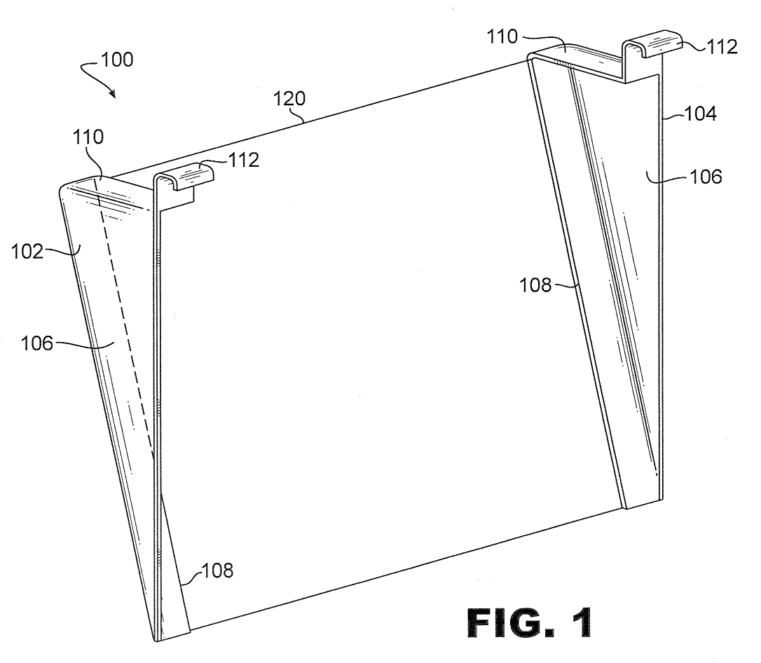

The invention in a first example as seen generally at 100 in FIG. 1, may comprise first and second housing members 102 and 104, formed as left and right hand members respectively, having triangular or other shaped side walls 106 and first and second flanges 108 and 110, extending away from the side wall along two sides. In one example, the housing members 102 and 104 may be formed to have approximately the cross-sectional shape of a right triangle such that the right angle is formed where the top wall of the housing member 102 and 104 meets the top region of a wall of the enclosure to which the apparatus is attached. The side wall 106 of each housing member may be dimensioned to correspond to the height of an enclosure with which it is to be used. The flanges 108 and 110 extend inwardly from the side wall on each of the right and left hand members 102 and 104, or toward the other housing member when positioned for use in association with an enclosure. The first and second housing members 102 and 104 may be positioned adjacent an edge of the enclosure along a wall thereof for use. To facilitate positioning of the housing members 102 and 104 in association with an enclosure, the housing members 102 and 104 may further comprise an attachment system 112, allowing the members 102 and 104 to be selectively attached to a wall of the enclosure. A background 120 or the like may then be positioned in association with the housing members to extend between the flanges 108 of each of the housing members 102 and 104. In this way, the housing members 102 and 104 in association with a background 120 thereby form a cavity, having the background 120 as a part thereof, such that the background 120 is positioned in proximity to a wall of the enclosure. A light source (not shown) may then be used to project illuminating light into the formed cavity, and thereby illuminate the background 120 such that it is uniformly illuminated, thereby enhancing the appearance of the enclosure when viewed. The members 102 and 104 may be cost-effectively formed of a plastic material which may be molded into the desired form. The housing members 102 may be easily packaged and transported in a cost-effective manner, and don't require significant shelf or storage space at retail or if not in use, as the members 102 and 104 can be stacked together in close fitting relationship. As an alternative, the members 102 and 104 could be formed in a double female type form to allow continuous horizontal connections therebetween, and facilitate manufacture, shipping and storage.

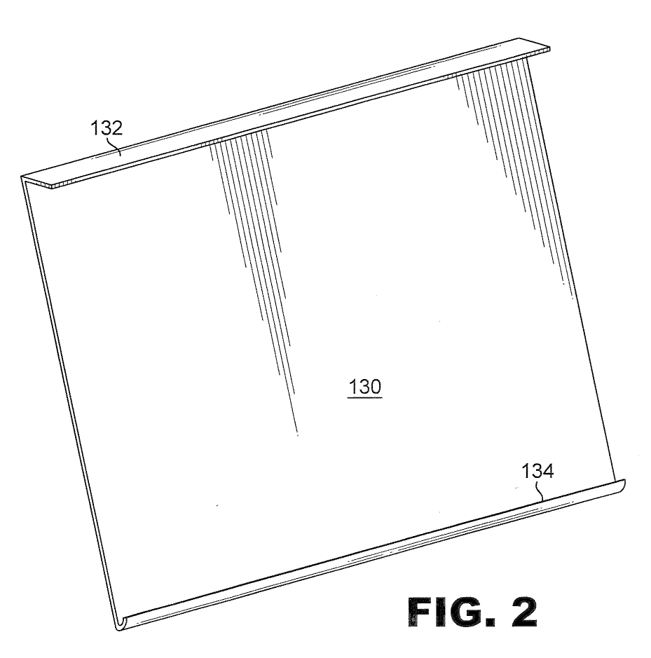

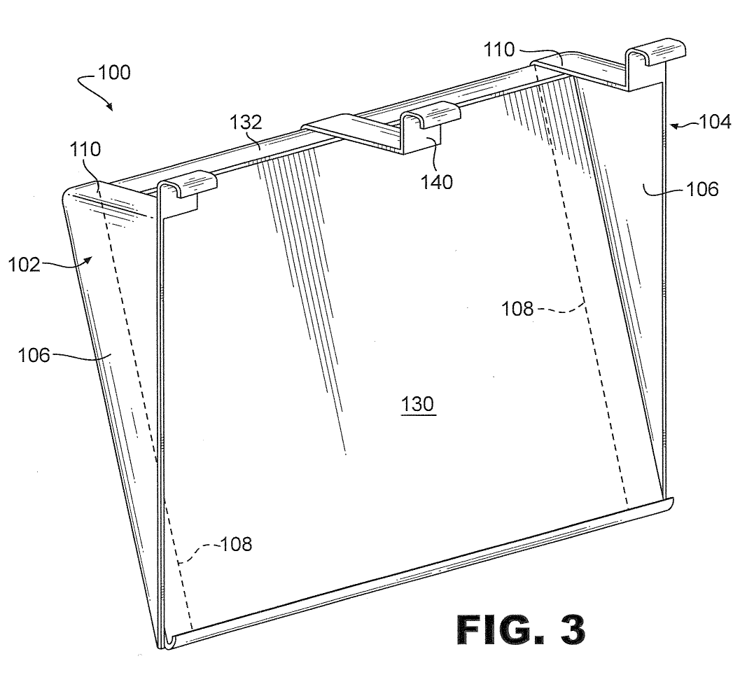

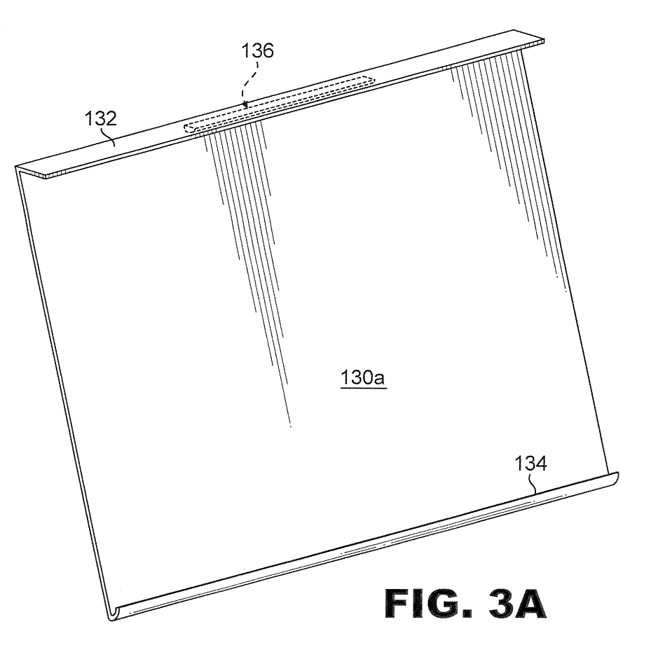

In a further example, there may also be provided a plate member 130 as shown in FIG. 2, adapted to connect the first and second housing members 102 and 104 along a back portion thereof, between extending flanges 108 on each housing member 102 and 104, if desired. The plate member 130 may be connected to the end housing members 102 and 104, such that a cavity is formed into which illuminating light may be directed. The plate member 130 may be formed to have a white or reflective interior surface if desired. For example, the plate member may be formed as a coextruded member having an interior white or reflective surface and an outer opaque layer. If the first and second housing members 102 and 104 are formed as having a triangular shape as shown, the plate member 130 may then be attached so as to be inclined relative to the open end of the cavity formed thereby, as shown in FIG. 3. In use, a background (not shown) may be selectively attached adjacent a wall of an enclosure, such that illuminating light is reflected from the cavity toward the background, so as to illuminate the background from behind it and into the enclosure. The center plate member 130 may be dimensioned such that in association with the housing members 102 and 104, the formed cavity is approximately the dimension of the wall of the enclosure with which it is used. The plate member 130 may have a top flange 132 which extends toward the wall of the enclosure when positioned therewith if desired. The top flange 132 may increase the structural integrity of the plate member 130, and may also provide a mounting position for a light source to be used therewith. The plate member 130 may also include a bottom support 134 to facilitate positioning of a background in association therewith. As shown in FIG. 3, the system may further include a center support and attachment member 140 to assist in mounting of the apparatus, and to help maintain stability of the plate member 130 if it has larger dimensions for example. The attachment system may simply be hook type arrangement adapted to engage a top portion of an enclosure wall. Other suitable attachment systems are contemplated. FIG. 3A shows an alternative plate member configuration 130a with a light source provided therewith, such as an LED strip 136 for providing illuminating light into the cavity. The use of an LED light source may provide desired illuminating light in an efficient manner, to illuminate a background positioned in association with the plate member 130 or positioned adjacent the enclosure with which it is used.

In these and other examples, the housing members 102 and 104 (or other housing configurations) may be injection molded in a cost-effective manner, and may be formed to have a desired appearance and/or texture. In an example, the housing members 102 and 104 may be made to have a desired color so as not to require any further treatment, such as painting or adding a reflective material thereto. The housing members 102 and 104 may be formed in a double or triple mirror image cavity mold, and may then be used on various size enclosures without modification for example, as the length of any enclosure can then be accommodated by a plate member having dimensions to fit a particular enclosure. If desired, the attachment system may also be provided only in association with the members 102 and 104, or only in association with a plate member 130. The dimensions of the housing members may also accommodate desired heights of enclosures, with initially manufactured dimensions provided for a larger enclosure, with the height adjusted by cutting the housing members to a desired smaller size if needed. The use of injection molding processes for example, may provide for cost-effective manufacture, as tooling costs are minimized by the versatility of the housing members 102 and 104. Molding may also virtually eliminate scrap material in the construction. The form of the housing members 102 and 104 further economizes packing and shipping or the system, maximizes shelf space and provides flexibility in use. Alternatively, processes such as thermoforming may be used to produce the desired housing configurations. Such a process may provide the desired configurations in a cost-effective manner, reducing tooling costs for example.

Further, in association with the illuminating apparatus, the cavity allows positioning of three-dimensional backgrounds therein, such as foam or other suitable material formed into a desired shape and decorated, while providing illumination thereof. For example, the three-dimensional background could be formed to emulate the appearance of desired objects or otherwise, such as rocks or rock formations, a piled slate type appearance, one or more ships or other maritime or aquatic items, themes using characters or objects, such as movie themes (e.g. Pirates of the Carribean or the like), NASCAR, sports teams, or any other background as desired. The space within the cavity allows for such three-dimensional backgrounds to be used, and adds depth to the appearance of the enclosure. The background, whether two dimensional and/or three-dimensional, may have connecting portions to engage and be connected to the housing members 102 and 104, thereby eliminating the need for a plate member 130 for example, or such backgrounds can be connected to a plate member 130 if desired. Alternatively or in addition, the background could be formed to include holographic images or other characteristics as may be desired to enhance the appearance. The illuminating light may also be controlled to provide varying illumination on the background, such as may be produced by light filtering through wave action in the ocean.

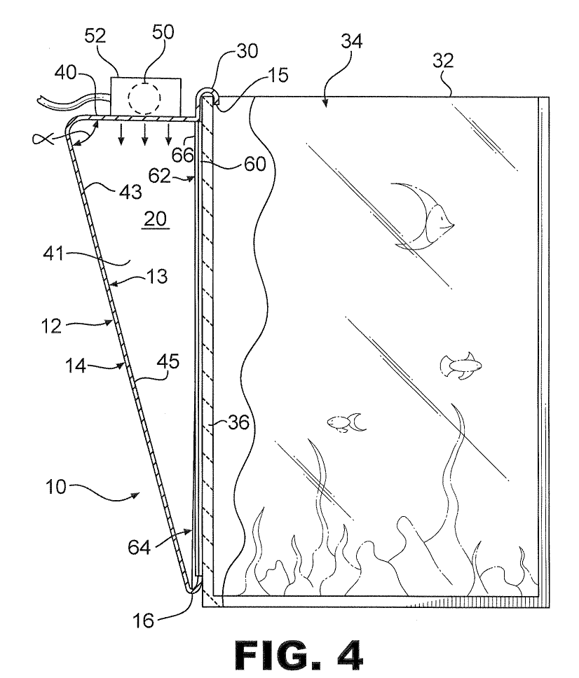

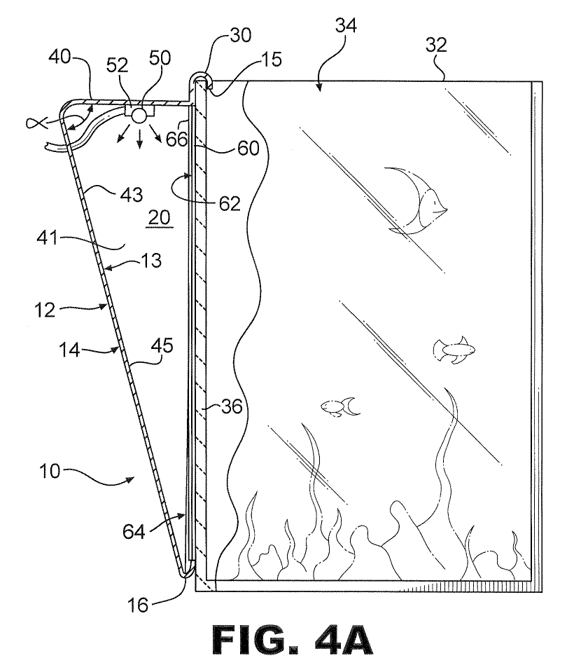

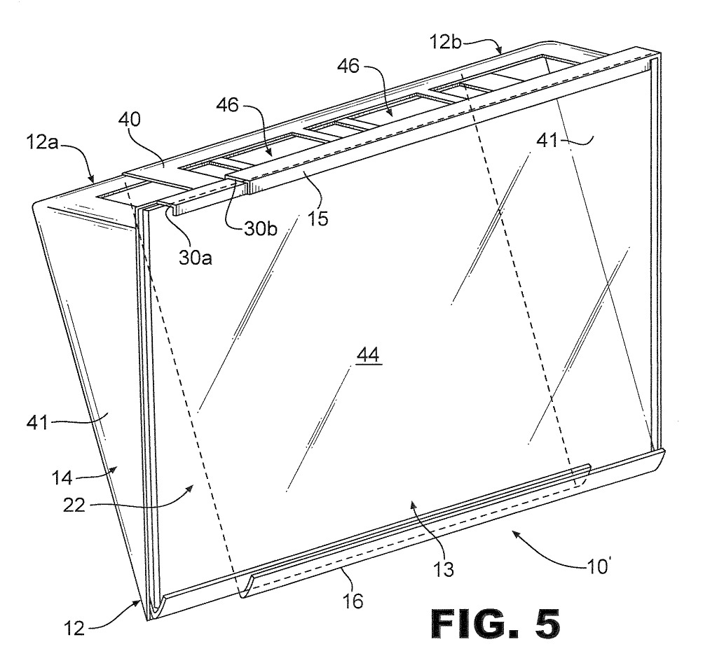

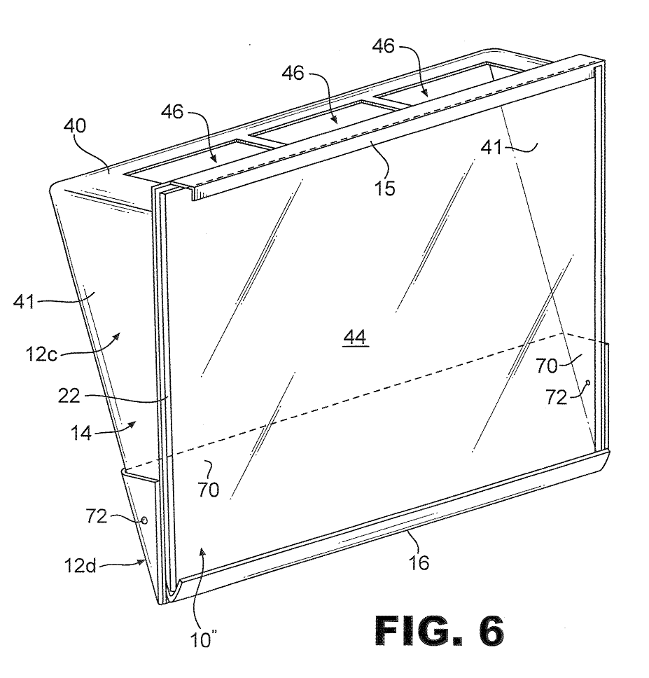

Further examples are shown in FIGS. 4 and 4A, wherein an apparatus 10 is provided, and 10′ and 10″ in FIGS. 5 and 6 respectively. The illumination system in these examples comprises a housing 12 having an inner surface 13, an outer surface 14, an upper edge 15, and a lower edge 16. In these examples, a back wall or panel 43 provides the inner and outer surfaces 13 and 14, while upper edge 15 is formed as part of a top panel 40. Housing 12 is shaped such that reflective cavity 20 is formed thereby. In the preferred example, cavity 20 is defined by substantially the entire inner surface 13 of housing 12. The cavity 20 is defined by housing 12 in association with a wall 36 of the aquarium, terrarium, or other like enclosure. The housing 12 is therefore formed to provide a large opening or a mouth 22 that coincides with the enclosure wall 36, being approximately defined by the perimeter of the housing 12, similar to the assembled apparatus as shown in prior FIGS.

Housing 12 includes attachment means for external attachment of the housing 12 to an aquarium, terrarium, or other similar enclosure as shown in FIG. 4. The attachment means may be a hook-shaped member 30 extending along at least a portion of the upper edge 15 of housing member 12. This will allow housing member 12 to be hung from the top edge 32 of a wall of enclosure 34 such that the opening or mouth 22 of reflective cavity 20 lies adjacent to a wall 36 of enclosure 34. The opening or mouth of reflective cavity 20 may have dimensions that substantially correspond to the dimensions of wall 36. Hook shaped portion 30 may be replaced by numerous means of attachment known in the art. Such attachment of the housing member 12 to enclosure 34 may additionally or alternatively be disposed at other locations upon the housing 12.

In one example, the top portion of outer surface 14 of housing 12 is shaped to form a substantially horizontal top panel 40 that joins at an acute angle α. with inclined back panel 43, similar to the position of plate member 130 in the prior example for instance. When installed upon an aquarium or other enclosure as seen in FIG. 4, top panel 40 meets at approximately a right angle with top portion of wall 36. Inclined back panel preferably extends from top panel 40 toward the wall 36 of the enclosure 34, designed to intersect the enclosure at substantially the bottom of wall 36. Therefore, when installed upon enclosure 34, housing 12 (and reflective cavity 20) will have the cross-sectional shape of a right triangle as seen in FIG. 4. In addition, in this example, the housing 12 will include side walls 41 extending from back wall 43 to fully enclose reflective cavity 20 by means of the walls of the housing in conjunction with the wall 36 of the enclosure 34. Providing a substantially closed reflective cavity 20 in conjunction with the wall 36 of enclosure 34 allows only illuminating light introduced into the reflective cavity 20 to contribute to illumination of a decorative background positioned adjacent wall 36.

Also, in this example, housing 12 includes at least one aperture 46 in the top panel 40 of said housing 12. As can be seen in FIG. 4, a light source 50, such as an ordinary incandescent or fluorescent light bulb, or a plurality of the same, is disposed upon top panel 40 to lie adjacent to the at least one aperture 46. Here the positioning of the light source 50 is above the top panel 40, with the light source 50 enclosed within a housing 52 such that light generated from source 50 will be directed downwardly into the reflective cavity 20 of housing 12. Also contemplated are other possible light source 50 positions that allow efficient projection of light into cavity 20.

Alternatively, as seen in FIG. 4A, the light source 50 can be positioned below the top panel 40 of housing 12. It may be enclosed within a housing 52 that allows light to be directed in a radial direction within reflective cavity 20 of housing 12.

The described configurations of housing 12, reflective cavity 20, and the location of the light source 50 will project light from the light source uniformly out through the mouth 22 of reflective cavity 20 to effectively backlight decorative background 60 which is disposed adjacent to wall 36 of enclosure 34. To facilitate this, the inclined back panel 43 with reflective inner surface 13 allows light to be reflected off its entire length to provide substantially equal illumination to the top area 62 of the decorative scene 60 and the bottom area 64 of the decorative scene 60. In this configuration, it is desirable to direct light from light source 50 to be incident upon the surfaces of the cavity 20 so that light incident upon the wall 36 of enclosure 34 is reflected from inner surface 13. The inclination of the back panel 43 allows light to be incident along the entire height of the back panel 43, and to reflect light toward wall 36 of enclosure 34 along the entire height of panel 43. Other configurations are contemplated. Further, in this or other configurations may allow light from the light source 50 to be reflected from a varying distance from wall 36 corresponding to the distance from the portion of the reflective surface to the light source 50. Thus, regions of the reflective surface closest to light source 50 are provided at a further distance from wall 36, while those portions of the reflective surface further from light source 50 are positioned closer to wall 36 of enclosure 34. These aspects of this shape or other shapes may therefore contribute to providing uniform illumination over the entire surface of wall 36 and thereby providing uniform illumination of the decorative background 60.

The inclined back panel 43 may be light reflective for reflecting light from a source out through the mouth of reflective cavity 20 and through decorative scene 60 disposed adjacent to wall 36 as shown by the light ray paths shown in FIG. 4. As seen in the examples of FIGS. 4 and 4A, the housing 12 may be formed entirely from a plastic type material, or other suitable materials. The reflective inner surface 13 of back panel 43 may thus be naturally light reflective or a light reflective material. A reflective laminate 45 may be adhered or otherwise disposed upon inner surface 13 of inclined back panel 43 to provide the light reflection if desired. As an example, the housing 12 may be constructed of an extruded plastic or polymeric material for example, and more particularly could be formed of co-extruded plastic or polymeric materials with an outer material layer and an inner material layer. The outer layer may be opaque and have a desired color to match the décor of an environment in which it is used, while the inner layer may be white or some other light reflecting color to provide the desired function.

In addition, the housing 12 includes a background mounting system, which may be an upper and lower end which provide slots for insertion and retention of the decorative background, or a support on which a decorative background is attached, or for a light altering panel as will be described. A lower retaining member 16, such as a slot or groove, is provided at the lower edge of inclined back wall 43. Any other supportive means that facilitates inserting and retaining a decorative background or a removable panel 44 (FIG. 10), which may be used for mounting of a decorative background, or could be a specially designed light altering, diffusing or diffracting panel. A space is also formed in association with top groove 30 for insertion of a decorative background and/or panel 44. A decorative background or panel 44 as seen in FIG. 10 may thus easily be inserted and removed from retention in the upper and lower hooked-shaped grooves to extend over mouth 22 of housing 12, as seen in FIG. 6 for example. Thus, housing 12 may remain attached to aquarium or selected enclosure 34 while miscellaneous decorative backgrounds and/or light diffusing/diffracting lens panels 44, may be chosen and exchanged as necessary to achieve any desired lighting and/or background effect.

As shown in FIG. 10, and described above, to facilitate mounting a decorative background, which are many times simply printed on paper or other material for example, a panel 44 may be provided. The panel 44 may be dimensioned to be slid into and be supported by the lower groove 16 of housing 12 and upper groove 30 as formed, or positioned to simply lie against the back wall of the cavity if desired. The panel 44 may simply be a clear plastic material, or if desired, may also provide light altering characteristics. For example, panel 44 may be translucent, single- or multi-colored, or may possess light transmissive, diffusive, diffractive, reflective, refractive, or filtering capabilities, or any light affecting or modifying capabilities, whether attenuating or pellucid etc., known in the art. The panel may also combine any such effect within one or more panels that can be fitted within the supporting mechanism, over mouth 22 of housing 12. The panel 44 can be made of plastic or like materials, or any material suited to producing a desired lighting effect and that can be readily supported by the mounting system of housing 12. Alternatively, a diffraction grating or any other optical device, or light transmitting or affecting means, may be used to produce a desired effect. If desired, a background scene may be printed thereon, such as by silk screening or the like, to provide the desired appearance.

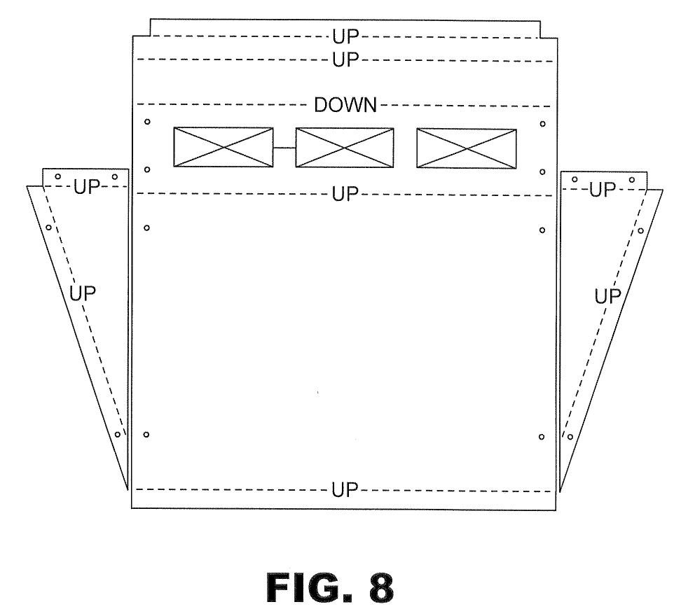

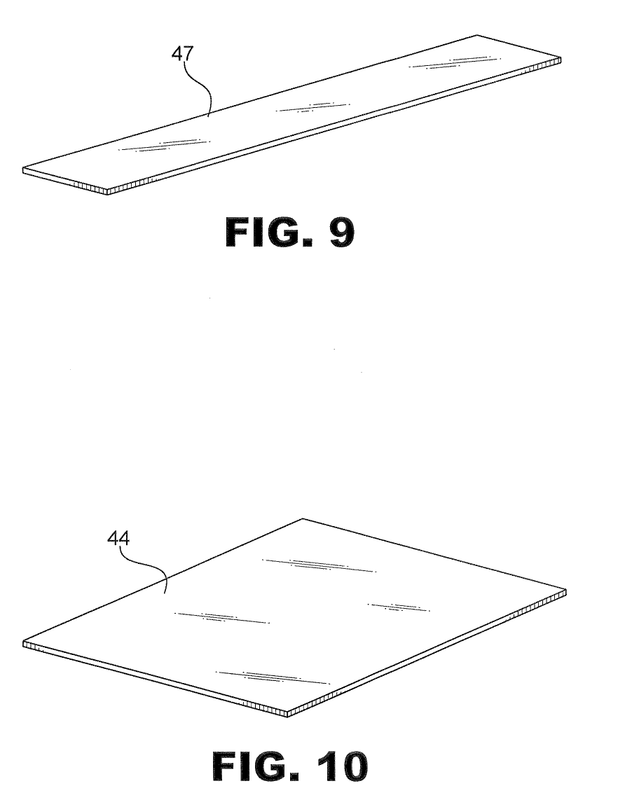

As shown in FIG. 9, a clear, translucent or colored lens 43 of appropriate size, or a diffraction grating, or any other light transmitting or affecting apparatus or optical device, may also be placed in or below the light source 50, in any of the examples herein. Such lens 43, grating, or other optical device may be placed separately on top panel or at mouth of the apparatus. In addition, any combination of lens or other optical device may be placed simultaneously at the top panel below a light source and at the mouth of the cavity.

As an alternative mounting of the decorative background either alone or in conjunction with a panel 44, the background and/or panel 44 is positioned along the back inclined wall 43 of the housing 12. For example, the background and/or panel 44 may be shorter such that when it is inserted into bottom groove 16, it does not engage top groove 30, but instead falls back to rest against inclined back panel 43 within bottom groove 16. Alternatively, or in addition, a slot may be provided in the housing members or housing of examples herein, so that a decorative background and/or panel 44 can be slid through it into a position along the inclined back wall. In the position along the back inclined wall 43, the light source shines directly on the decorative background and/or panel 44, and reflects through the enclosure wall 36 so that it is clearly visible. It is understood that the chosen light source 50 or sources may be of any frequency. That is, the desired illumination may be from one or more regular (white), colored, multi-chromatic or multi-spectral sources. The choice of lens or other optical device and/or its placement within housing 12, as well as the appropriate light source 50, may provide a variety of desired lighting effects.

In another example, a diffusing device that diffuses or scatters light incident thereon to more uniformly direct light rays toward wall 36 of the enclosure 34 may be used. One aspect of the invention is, when desired, to uniformly illuminate the decorative background over the entire surface of wall 36, without causing point sources of light behind the decorative scene. Such point sources may detract from providing an illuminated background that appears natural. In this example, the diffusing means will, preferably, scatter light rays incident thereon in a wide variety of directions to avoid the creation of any point sources of light. The diffusing means may be provided as a roughened reflective surface provided as inner surface 13 of housing 12, with roughening of the surface causing light incident upon the reflective surface to be scattered as it is reflected thereby. Alternatively, the reflective surface itself may be provided as a diffusion grating or the like, also acting to scatter light instant thereon. It should be understood that the diffusing system of the preferred example will not substantially affect reflection of light from the reflecting inner surface 13 toward the wall 36 of enclosure 34, but will scatter the light in a way to provide more uniform illumination over the entire surface of wall 36. Also to prevent the creation of any point sources of light in the illuminated background, it may be desirable to provide a screen 66 or further diffusing means positioned in the path of light originating from the light source 50 which would be incident upon the back wall 36. This screen 66 may also include a reflective surface to reflect light incident thereon back toward the reflective inner surface 13, or alternatively, the screen 66 may be constructed of diffusing means such as a diffusion grating or the like, causing scattering of light incident thereon.

As seen in FIG. 5, a further example of the invention 10′ includes housing 12 formed from two complementary members, a plurality of members, such as a first member 12a and a second member 12b. The members 12a and 12b slidably fit together to provide a means for adjusting the length of the housing 12. This slidable fit can be accomplished in numerous ways that are well known in the art, such as by telescoping movement therebetween. For example, hook shaped groove 30a of first member 12a may slidably receive hook shaped groove 30b of second member 12b to provide adjustment of the overall length of housing 12.

In another example, seen in FIG. 6 at 10″, housing 12 may alternatively be formed from a separate top member 12c and bottom member 12d, to allow for slidable height adjustment of the housing 12. Top member 12c is preferably slidably received in groove 70 of bottom member 12d. Top member 12c and bottom member 12d may simply be frictionally secured together or selectively secured together by fastening means, such as screw 72; which may be provided to force top member 12c into frictional engagement with bottom member 12d. Groove 70 may alternatively or additionally be formed in top member 12c. The adjustability is not meant to be limited to complimentary members that slidably fit together, and many other suitable systems for providing the apparatus with adjustability will be apparent to those skilled in the art. Both the length and height adjustability of the examples shown in FIGS. 5 and 6 allow the illuminating apparatus to be fitted to any particular size aquarium or like enclosure in an easy manner. As the shapes and sizes of such enclosures vary largely, the adjustability of the apparatus as to its height or length dimension allows the apparatus to be adapted to a particular enclosure without affecting the advantages obtained thereby. It should be also be recognized that the housing 12 may be configured to work with differently shaped aquariums or like enclosures, such as circular tanks, with the reflective cavity corresponding substantially to the shape of the wall of the enclosure through which illuminating light is to be directed by means of the apparatus.

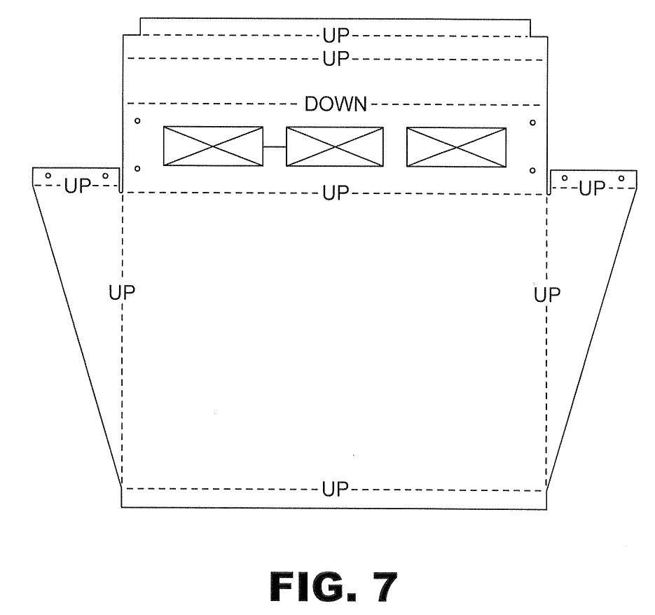

As seen in FIGS. 7 and 8, the housing may be cost-efficient to manufacture and ship and easy to assemble. It could be formed or stamped out of a suitable cost-effective, material that is conducive to being formed in a flat blank for subsequent assembly into the housing 12. In this regard, a ready-made or semi-ready-made assembly, such as seen in FIGS. 7 and 8, is contemplated. Such configurations provide a housing apparatus 12 that is deliverable in a flat, cost-effective package, and which can be readily assembled for use. Cut-outs and/or fold lines may be formed in the material to provide the desired housing 12 when fully formed. As shown in these examples, the flat blank may be one or more pieces, and can have multiple fold lines formed therein to allow formation of top and sides in conjunction with a back panel to form the apparatus according to various examples. Further, additional fold lines at the sides of the flat blank may form the mounting system adjacent the top and bottom of the flat blank. Folding may be accomplished by cold forming techniques for example, and produced by score lines or the like.

While the foregoing description has set forth selected examples of the invention in particular detail, it must be understood that numerous modifications, substitutions and changes can be undertaken without departing from the true spirit and scope of the present invention as defined by the ensuing claims.

What is claimed is:

1. An apparatus for illuminating a decorative background disposed in proximity to a wall of an enclosure, the apparatus comprising:
first and second housing members having an inner surface, an outer surface, an upper edge, and a lower edge, wherein at least part of said inner surface defines a portion of an illuminating cavity,
a background positioned in association with the cavity,
a light source disposed to introduce light into the cavity and to illuminate the background,
an attachment mechanism associated with the housing members and/or background to allow the cavity to be selectively attached to the enclosure such that the reflective cavity lies exterior to and adjacent with at least a portion of the enclosure, wherein light from the light source is selectively projected into the cavity to illuminate the background.

2. The apparatus of claim 1, wherein the first and second housing members are formed as mirror image members.

3. The apparatus of claim 1, wherein the first and second housing members are formed to have a right triangular shape with a side wall portion and a back wall portion inclined to wall of the enclosure when positioned adjacent thereto.

4. The apparatus of claim 1, wherein the first and second housing members are formed to have a mounting portion associated therewith to allow the housing members to be attached to the enclosure at a top portion thereof.

5. The apparatus of claim 1, wherein the first and second housing members are formed to have supporting portion at a bottom thereof in which a background or background supporting member may be selectively supported.

6. The apparatus of claim 1, further comprising a plate member selectively attached to the first and second housing members to form the cavity.

7. The apparatus of claim 6, wherein the plate member is formed to have an interior reflecting surface.

8. The apparatus of claim 6, wherein the plate member has a supporting portion at a bottom thereof in which a background or background supporting member maybe selectively supported.

9. The apparatus of claim 6, wherein the plate member has a top wall formed as a part thereof.

10. The apparatus of claim 9, wherein the top wall has an illuminating light attached thereto.

11. The apparatus of claim 1, wherein the background is positioned either directly adjacent the enclosure such that illuminating light introduced into the cavity backlights the background or positioned such that illuminating light introduced into the cavity directly illuminates the background.

12. The apparatus of claim 1, wherein the background is selected from the group consisting of two-dimensional, three-dimensional, holographic, theme-oriented or combinations thereof.

13. An apparatus as recited in claim 1, further comprising,
a light altering system positioned relative to said cavity to selectively alter the characteristics of light directed into the enclosure from the cavity.

14. An apparatus as recited in claim 1, wherein the first and second housing members are formed as a flat blank having fold lines to selectively form the housings for use.

15. An apparatus for illuminating a decorative scene disposed in proximity to a wall of an enclosure, the apparatus comprising:
a housing having an inner surface, an outer surface, an upper edge, and a lower edge, wherein at least part of said inner surface defines a cavity having a mouth and an inclined back wall,
a light source disposed to introduce light into said cavity and onto said inclined back wall of said housing,
an attachment mechanism associated with said housing for allowing said housing to be selectively attached to said enclosure such that said mouth of said reflective cavity lies exterior to and adjacent with at least a portion of said wall of said enclosure;
a supporting system for selectively supporting and retaining a removable decorative background and/or panel within said housing in a predetermined position relative to said wall of an enclosure, wherein light projected into said cavity and onto said inclined back wall is reflected through the mouth of the cavity.

16. An apparatus as recited in claim 15, wherein,
the supporting system comprises at least a mounting groove formed along a bottom edge of said housing.

17. An apparatus as recited in claim 16, wherein,
the supporting system further comprises a mounting groove formed at the upper edge of the cavity for positioning the decorative background substantially over said mouth of the cavity

18. An apparatus as recited in claim 15, further comprising,
a light altering system positioned relative to said cavity to selectively alter the characteristics of light reflected into the enclosure.

19. The apparatus as recited in claim 15, wherein,
the housing includes a slot through which a decorative background and/or panel is selectively inserted into a position adjacent the inclined wall.

20. The apparatus as recited in claim 15, wherein the housing is formed of at least flat blank comprising fold lines to selectively form the housing for use.
